(19) United States
(12) Patent Application Publication
(10) Pub. No.: US 2020/0034840 A1
(43) Pub. Date: Jan. 30, 2020

(54) Identifying Recipients for Restricted Giving

(71) Applicant: Natalie Grace Bax, Sierra Madre, CA (US)

(72) Inventor: Natalie Grace Bax, Sierra Madre, CA (US)

(21) Appl. No.: 16/045,681

(22) Filed: Jul. 25, 2018

(51) Int. Cl. G06Q 20/40; G06Q 20/34; G06Q 50/22

(52) U.S. Cl. CPC G06Q 20/405; G06Q 50/22; G06Q 20/4014; G06Q 20/351

(57) ABSTRACT

A searchable registry of information on recipients of charity which enables a giver to identify a recipient based on having observed the recipient, and means for the giver to give a donation to the recipient, with the option of the giver imposing restrictions on how the donation is spent.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

When a potential giver of charity sees a potential recipient holding up a sign to ask for money, they may think of contributing. However, they may not have time to stop and give money, may not have appropriate bills or coins with them, or may not want to delay traffic behind them by pausing to give money. The potential giver may also worry that someone other than the potential recipient would take the money from the potential recipient by force or threat of force. Additionally, the potential giver may worry that the potential recipient might spend the money irresponsibly.

The potential giver might instead give to an organization that promises to give responsibly to the needy. However, the potential giver may worry that the organization will overspend on administration. The potential giver may also worry that the potential recipient would not receive anything from the organization, either because the organization would refuse to give to the potential recipient or because the potential recipient does not know how to contact the organization. Instead, the giver might want to contribute directly to the person who is asking for money.

So there is a need for a system and method to give charity that allows the giver to donate to someone based on having observed them. It is useful for the giver to be able to restrict how the donation may be spent by the recipient. It is also useful if the delivery of the donation to the recipient has safeguards to prevent someone who is not the intended recipient from collecting the donation.

### SUMMARY

A system and method to maintain a searchable registry of recipients so that a giver who has observed the recipient can identify which recipient they have observed and can donate to that recipient, with the option of imposing restrictions on how the donation is spent.

### DESCRIPTION OF THE DRAWINGS

FIG. 1 shows the steps of the method: recipient registration and display of identifying information, giver selection of recipient from registry and donation, and recipient receiving the donation.

FIG. 2 shows an embodiment as a system.

FIG. 3 shows the process of a giver searching the registry to identify a recipient.

### DETAILED DESCRIPTION

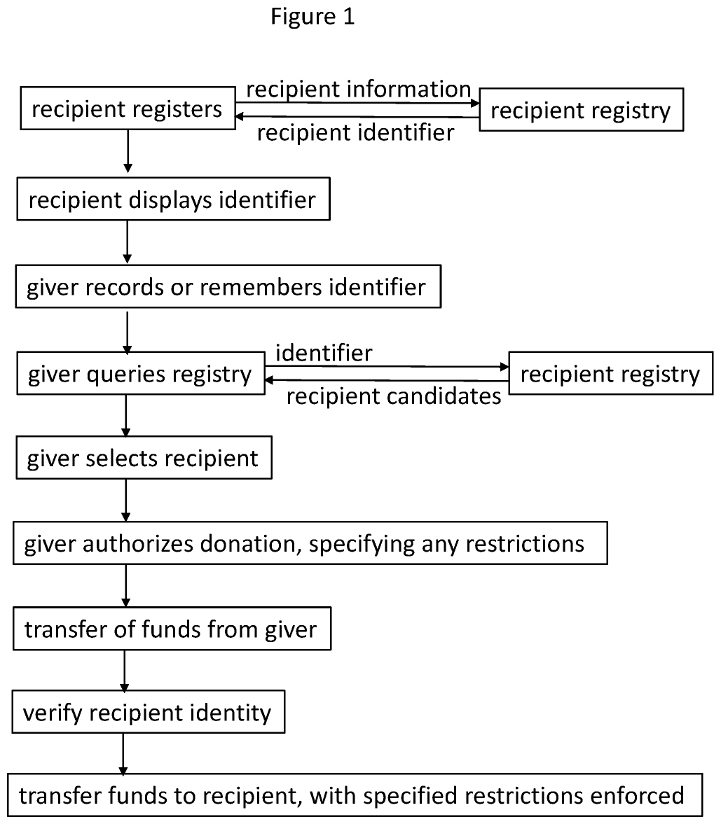

FIG. 1 shows steps of the invention:

1. Recipient registers. Information about a recipient is added to a registry. The information may be used to identify the recipient, to deliver donations to the recipient, and to verify the recipient's identity as a prerequisite to being given or spending donations. The recipient may submit an identifier, or one may be generated for the recipient. The identifier may include a number, a symbol, a sequence of symbols such as a word or phrase, a photo of the recipient, a photo of a sign the recipient displays, or a location where the recipient can be seen. The recipient information used for delivering donations may be an address, information used to access a bank account, debit card account, or online payment system, or information about where to meet the recipient and when. The recipient information used for verifying identity may include a photo of the recipient, information about which forms of identification the recipient owns, the name of the recipient, or biometric information such as a thumbprint.

2. Recipient displays identifier. The recipient displays their identifying information, for example adding a word or symbol to a sign that they hold to ask for money. For identifying information consisting of a photo of the recipient, the sign they use when requesting donations, or the location where they ask for donations, it is sufficient for the recipient to show themselves, show their sign, and be in their registered location, respectively.

3. Giver records or remembers identifier. The giver may take a photo, capture an image using a mobile computing device such as a mobile phone or tablet, write down the identifying information, or remember it.

4. Giver queries registry. The giver submits identifying information or a photo of identifying information to the registry. The registry returns information for each candidate recipient in a list, with the list based on matching or partially matching the submitted identifying information to identifying information for registered recipients.

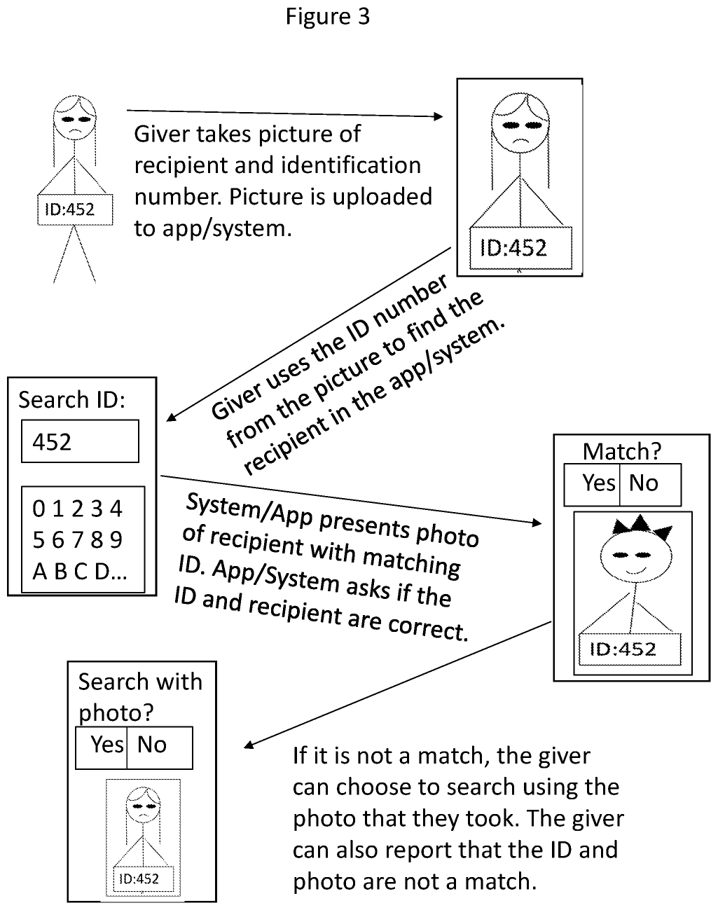

5. Giver selects recipient. The giver either selects a recipient from the candidates or iteratively adds more or uses different identifying information, re-submits the query, and receives an updated list of candidate recipients until the giver identifies a recipient. Also, the giver may report any possible false match, for example if one recipient is using the same number and looks similar to a different recipient. FIG. 3 illustrates this process.

6. Giver authorizes donation, specifying any restrictions. The giver authorizes a donation from themselves to a selected recipient. The giver may also specify restrictions on how the donation may be spent.

7. Transfer funds from giver. Funds are transferred for the donation. The transfer may be electronic, from a bank account, through an online payment system, or through a credit card.

8. Verify recipient identity. The recipient's identity may be verified as a prerequisite for giving them the donation. Verification may include checking identification documents, checking for a biometric match, or checking that the recipient matches a photo of them in the recipient registry.

9. Transfer funds to recipient, with specified restrictions enforced. The funds transfer may be accomplished by giving the recipient cash, mailing or giving the recipient a gift card or check, by transferring money to the recipient electronically: to a bank account, to on online payment system account, to add funds to a debit card, to a cryptocurrency account, or through a wire transfer. The restrictions on how a donation may be spent may be enforced by only giving a recipient gift cards for merchants that do not sell precluded items or by giving gift cards or debit cards or other forms of funding that have spending restrictions enforced at the point of sale, through cooperation with a merchant, a government, or both, for example an electronic benefits transfer card with the same spending restrictions as for those issued by the Supplemental Nutrition Assistance Program (SNAP).

Extensions or alternatives to these basic steps may comprise:

A. Inform the giver about the amount of contributions received through the system by the recipient over time. Do this after the giver identifies the receiver and before the giver contributes to the receiver. The giver may find this information valuable in deciding whether to give.

B. Similarly, inform the giver about how and whether the recipient has spent past contributions. This may also influence whether the giver decides to give, and with what spending restrictions.

C. Verify that the recipient is the same person as the spender at the point of sale (POS), where the donation is spent. For example, use the system to find a photo of the recipient who was given the contribution being spent, and have the checkout worker confirm that the spender looks the same as the recipient before allowing spending.

D. Check the registry for recipients with more than one registration. Allow only a single registration per recipient, merging multiple registrations if they are for the same recipient.

E. Use verification after spending to enforce restrictions on how donations are spent. For example, distribute a contribution as a debit card, and inform the recipient of the debit card of the restrictions on spending. Monitor the items bought with the card. If those items include restricted items, then discontinue delivering donations to the recipient until the recipient reimburses the amount spent on restricted items.

F. In addition to other recipient information, the recipient may submit requests for specific types of donations, which can be presented to givers during or after the process of the giver selecting a recipient. Examples include a recipient requesting a gift card to spend at a pet store because the recipient owns a pet and a recipient requesting advice, a ticket for transportation, or some type of equipment in lieu of funds.

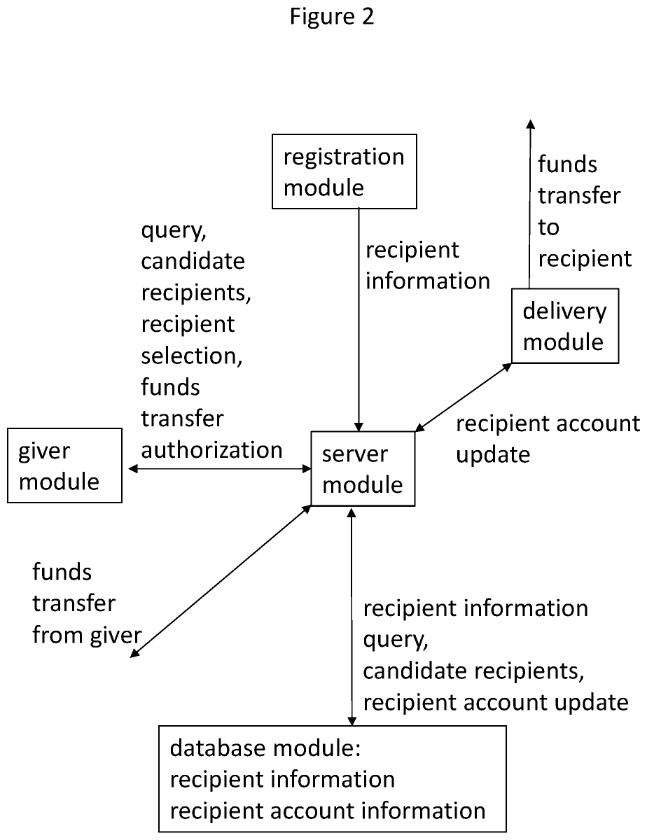

FIG. 2 shows a system view of an embodiment of the invention. The server module and database module together implement the functionality of the recipient registry from the method description. The system comprises:

1. A database module that comprises a hardware processor and memory comprising instructions executable by the processor. The database module stores recipient data, including identification data and account information for each recipient, indicating the donations received from givers that are still owed to the recipient. The database module may also store some combination of: information on how to provide contributions to each recipient, information to confirm the identity of a recipient, for example a photo of the recipient, information on restrictions on spending for donations, account history for recipients, and information on givers, including information needed to transfer money from giver accounts to receiver accounts.

2. A server module that comprises a hardware processor and memory comprising instructions executable by the processor. The server module receives queries and requests from other modules and operates as an interface to the database module. The server module receives registration information and forwards it to the database module to register recipients. The server module receives queries from givers, translates them into queries on recipient registration information for the database module, and returns results from those queries to givers. The server module effects transfers of funds from givers for donations to recipients, by accessing online banking or online payment system interfaces. The server module also processes updates to recipient accounts, to account for donations and deliveries to recipients. In addition, the server module may receive information on spending restrictions for donations and transfer that information to the database module for storage.

3. A delivery module that delivers donations to recipients. The delivery module may comprise a computer that orders a gift card and sends it to a recipient by mail or emails it to a recipient. Alternatively, the delivery of funds may be purely electronic, for example a recipient may receive a debit card upon registration, and the value limit for the debit card may be raised online to reflect contributions as they are received or donations may be delivered to a recipient's external account by accessing online banking or online payment system interfaces. As another alternative, the delivery module may be a physical space where recipients may go to receive gift cards as they receive contributions; the space may be an office based in a building or a mobile office based in a vehicle. The delivery module may confirm a recipient's identity as a prerequisite to delivering a donation. Verification may comprise validation against the recipient's information as stored in the database module, for example comparing the person claiming to be the recipient to their photo as stored in the database module.

4. A registration module that comprises instructions executable by a processor and recorded in a non-transitory medium for execution on a mobile device or a desktop computer. The registration module is used by recipients or their representatives to register recipients, sending recipient information to the server module, which records it in the database module. Additionally, the registration module may generate an identification code for the recipient to display while requesting donations.

5. A giver module comprises instructions executable by a processor and recorded in a non-transitory medium for execution on a mobile device or a desktop computer. The giver module is used by givers to query for candidate recipients, select a recipient from the query results, and authorize funds transfer to a recipient for a donation. The giver may also use an image-recording device such as a mobile phone to capture an image of a recipient, which can comprise the query. Alternatively, the user may memorize identifying information about the recipient, then use that information to formulate a query. The giver module may include functionality for a giver to restrict how a donation may be spent.

I claim:

1. A method to facilitate the giving of charity, comprising:
(a) registering identifying information for recipients to form a registry,
(b) recipients displaying some identifying information,
(c) a giver using identifying information of recipients to identify a recipient by searching the registry,
(d) a giver selecting a contribution for the identified recipient,
(e) the identified recipient receiving the contribution.

2. The method of claim 1 wherein said identifying information comprises one or more of: a picture of a sign the recipient displays, a picture of the recipient, a picture of the recipient with the sign, a string of characters, or a symbol that the recipient displays.

3. The method of claim 1 wherein said identifying information comprises one or more locations.

4. The method of claim 1 wherein displaying some identifying information comprises displaying a sign.

5. The method of claim 1 wherein a giver uses a device to record an image of the recipient.

6. The method of claim 5 wherein the image is matched against images in the registry to identify a recipient.

7. The method of claim 1 wherein a giver searching the registry comprises submitting identifying information, receiving information on a set of candidate receivers, and selecting a receiver from the set of candidate receivers.

8. The method of claim 1 wherein the contribution is a form of restricted giving.

9. The method of claim 8 wherein the restricted giving comprises gift cards.

10. The method of claim 8 wherein the restricted giving comprises restrictions on spending that imitate those of a government assistance program.

11. The method of claim 8 wherein the restrictions on spending are enforced at the point of sale.

12. The method of claim 8 wherein donation spending is monitored, and spending on restricted items is required to be reimbursed by the recipient before delivering subsequent donations to the recipient.

13. The method of claim 1 with the additional step of informing the giver about the history of contributions received by the identified receiver over time.

14. The method of claim 1 with the additional step of verifying that the spender of the contribution is the same person as the identified receiver.

15. The method of claim 14 wherein the verifying comprises comparing an image of the identified recipient to the spender.

16. A system for a giver to donate to a recipient after encountering the recipient, without having to find the recipient again, the system comprising:
(a) a database module, comprising: a hardware processor and memory comprising instructions executable by the processor that when executed cause recipient registration information to be stored, update recipient accounts to reflect contributions from givers, and update recipient accounts to reflect donations being delivered to recipients
(b) a server module, comprising: a hardware processor and memory comprising instructions executable by the processor that when executed receive recipient registration information and send it to the database module, receive queries from givers and respond to them with information about registered recipients, and communicate with an internet-based banking interface or online payment system to process donations
(c) a delivery module that sends donations to recipients.

17. The system of claim 16, with the delivery module comprising: a hardware processor and memory comprising instructions executable by the processor that when executed cause electronic gift cards to be sent to recipients.

18. The system of claim 16, with the server, database, and delivery modules configured for a giver to select restrictions on how their donations may be spent by a recipient.

19. The system of claim 18, with a form of restriction being restrictions on spending that imitate those of a government assistance program.

20. A non-transitory medium comprising instructions that can be read and executed by computer, that when executed perform a method for searching for a recipient's registration information, a method for a giver to specify a donation to the recipient, and a method to store an account of donations for a recipient.
